(19) United States
(12) Patent Application Publication
(10) Pub. No.: US 2026/0054456 A1
(43) Pub. Date: Feb. 26, 2026

(54) THREE-PHASE COMPOSITE, AND PREPARATION METHOD AND USE THEREOF

(71) Applicant: Harbin Engineering University, Harbin City (CN)

(72) Inventors: Linzhi WU, Harbin City (CN); Guocai YU, Harbin City (CN); Yang JIN, Harbin City (CN); Zheng ZHAO, Harbin City (CN); Mingyu LIU, Harbin City (CN); Fanglin CONG, Harbin City (CN); Chengyang WANG, Harbin City (CN); Zhuang LIN, Harbin City (CN)

(73) Assignee: Harbin Engineering University, Harbin City (CN)

(21) Appl. No.: 18/944,712

(22) Filed: Nov. 12, 2024

(30) Foreign Application Priority Data
Aug. 21, 2024 (CN) 202411147256.5

(51) Int. Cl. B29C 65/48; B29K 23/00; B29K 507/04; B29K 509/08

(52) U.S. Cl. CPC B29C 65/4805; B29C 65/4875; B29C 65/4885; B29K 2023/12; B29K 2507/04; B29K 2509/08; B29K 2863/00; B29K 2995/0053; B29K 2995/0094

(57) ABSTRACT

A three-phase composite, and a preparation method and use thereof are provided. The three-phase composite includes a hollow glass microsphere composite foam and a plurality of carbon fiber tubes filled in the hollow glass microsphere composite foam; where the carbon fiber tubes are arranged in a two-dimensional closest packing manner, two adjacent carbon fiber tubes have a center-to-center spacing of 29.9 mm to 34 mm, and each of the carbon fiber tubes has a wall thickness of 0.45 mm to 1 mm; and two ends of each of the carbon fiber tubes each are sealed by an end cap.

### CROSS REFERENCE TO RELATED APPLICATION

This patent application claims the benefit and priority of Chinese Patent Application No. 202411147256.5 filed with the China National Intellectual Property Administration on Aug. 21, 2024, the disclosure of which is incorporated by reference herein in its entirety as part of the present application.

### TECHNICAL FIELD

The present disclosure belongs to the technical field of solid buoyancy materials, and in particular relates to a three-phase composite, and a preparation method and use thereof.

### BACKGROUND

Solid buoyancy material is a lightweight material with low density and high strength. Traditional solid buoyancy materials are mostly two-phase epoxy synthetic foams prepared by infusing glass microspheres with an epoxy resin. In order to further reduce the density of the solid buoyancy materials, three-phase composite buoyancy materials have been proposed, generally by doping discontinuous fibers to reduce density or increase strength of materials. However, the improvement on a specific strength of the materials by doping with the discontinuous fibers is limited, thus restricting the scope of application.

### SUMMARY

In view of this, the present disclosure provides a three-phase composite, and a preparation method and use thereof. In the present disclosure, the three-phase composite shows better compressive resistance while having a smaller density, which could expand the application range of the three-phase composite as a solid buoyancy material.

In order to solve the above technical problems, the present disclosure provides a three-phase composite, including a hollow glass microsphere composite foam and a plurality of carbon fiber tubes filled in the hollow glass microsphere composite foam; where
the carbon fiber tubes are arranged in a two-dimensional closest packing manner, two adjacent carbon fiber tubes have a center-to-center spacing of 29.9 mm to 34 mm, and each of the carbon fiber tubes has a wall thickness of 0.45 mm to 1 mm; and two ends of each of the carbon fiber tubes each are sealed by an end cap.

In some embodiments, a standard piece of the three-phase composite has a cross-section shape selected from the group consisting of a circle, a hexagon, and a square, and the standard piece of the three-phase composite has a height of 150 mm to 500 mm.

In some embodiments, each of the carbon fiber tubes has an inner diameter of 26 mm to 30 mm.

In some embodiments, each of the carbon fiber tubes is prepared by a process including the steps of:
subjecting a thin-layer carbon fiber prepreg and a thick-layer carbon fiber prepreg to orthogonal lamination in a carbon fiber direction to obtain a laminated carbon fiber prepreg, and rolling the laminated carbon fiber prepreg to obtain a tube blank; where a thickness ratio of the thin-layer carbon fiber prepreg to the thick-layer carbon fiber prepreg is in a range of 1:2; and
winding a biaxially oriented polypropylene (BOPP) film on a surface of the tube blank, and then conducting curing and demolding in sequence to obtain a carbon fiber tube.

In some embodiments, the curing includes low-temperature curing and high-temperature curing in sequence, the low-temperature curing is conducted at a temperature of 75° C. to 85° C. for 25 min to 35 min, and the high-temperature curing is conducted at a temperature of 120° C. to 140° C. for 110 min to 130 min.

In some embodiments, the end cap is prepared by a material selected from the group consisting of a carbon fiber, a titanium alloy, and an aluminum alloy, and the end cap has a shape selected from the group consisting of a sheet and a hemispherical shell.

In some embodiments, the hollow glass microsphere composite foam has a density of 0.4-0.5 g/cm³.

The present disclosure further provides a method for preparing the three-phase composite described in the above technical solutions, including a method 1 or a method 2; where

the method 1 includes the following steps:
preparing a mold according to a shape of the three-phase composite; and
arranging the plurality of carbon fiber tubes in the mold and pouring a mixture of a glass microsphere and an epoxy resin into the mold, and then conducting curing and molding to obtain the three-phase composite; and

the method 2 includes the following steps:
processing a cured hollow glass microsphere composite foam to obtain the hollow glass microsphere composite foam with pores; and
embedding the plurality of carbon fiber tubes in the pores, and then conducting sealing and adhesion to obtain the three-phase composite.

In some embodiments, an adhesive for the sealing and adhesion includes an epoxy resin.

The present disclosure further provides use of the three-phase composite described in the above technical solutions or the three-phase composite prepared by the method described in the above technical solutions as a buoyancy material.

The present disclosure provides a three-phase composite, including a hollow glass microsphere composite foam and a plurality of carbon fiber tubes filled in the hollow glass microsphere composite foam; where the carbon fiber tubes are arranged in a two-dimensional closest packing manner, two adjacent carbon fiber tubes have a center-to-center spacing of 29.9 mm to 34 mm, and each of the carbon fiber tubes has a wall thickness of 0.45 mm to 1 mm; and two ends of the carbon fiber tube each are sealed by an end cap. In the present disclosure, an overall specific strength of a material is further improved by inserting high-strength carbon fiber tubes in two-dimensional closest packing into a traditional two-phase solid buoyancy material, the hollow glass microsphere composite foam. In the present disclosure, continuous fibers in the carbon fiber tube (prepared from a carbon fiber prepreg) improve a load-bearing capacity of the three-phase composite. At the same time, limiting the center-to-center spacing of the adjacent carbon fiber tubes within a certain range could improve the hydrostatic strength of the material, thereby improving the compressive performance of structural parts of the three-phase composite. The three-phase composite has a relatively low density of (0.2-0.4) g/cm³ and desirable compressive resistance, and could be used in a water depth of 500 m with a safety factor of 3 times.

### BRIEF DESCRIPTION OF THE DRAWINGS

FIG. 1 shows a schematic diagram of a process for preparing carbon fiber tubes and a three-phase composite by the method 2 as an example;

FIG. 2 shows a schematic structural diagram of the three-phase composite prepared in Example 1, where 1 refers to a carbon fiber tube, and 2 refers to a hollow glass microsphere composite foam; and

FIG. 3 shows an exploded diagram of the structural schematic diagram of the three-phase composite prepared in Example 1, where 1 refers to a carbon fiber tube, 2 refers to a hollow glass microsphere composite foam, and 3 refers to an end cap.

### DETAILED DESCRIPTION OF THE EMBODIMENTS

The present disclosure provides a three-phase composite, including a hollow glass microsphere composite foam and a plurality of carbon fiber tubes filled in the hollow glass microsphere composite foam.

In the present disclosure, the carbon fiber tubes are arranged in a two-dimensional closest packing manner in the hollow glass microsphere composite foam. In some embodiments of the present disclosure, two adjacent carbon fiber tubes have a center-to-center spacing of 29.9 mm to 34 mm, and preferably 30.4 mm to 33.5 mm. In some embodiments of the present disclosure, each of the carbon fiber tubes has a wall thickness of 0.45 mm to 1 mm, and preferably 0.5 mm to 0.8 mm. In some embodiments of the present disclosure, a standard piece of the three-phase composite has a cross-section shape selected from the group consisting of a circle, a hexagon, and a square, and preferably the hexagon. In some embodiments of the present disclosure, the standard piece of the three-phase composite has a height of 150 mm to 500 mm, and preferably 200 mm to 400 mm. In the present disclosure, axes of the carbon fiber tubes in the three-phase composite are parallel to each other. In some embodiments of the present disclosure, each of the carbon fiber tubes has an inner diameter of 24 mm to 30 mm, and preferably 27 mm.

In the present disclosure, two ends of the carbon fiber tube each are sealed by an end cap. In some embodiments of the present disclosure, a material of the end cap is selected from the group consisting of a carbon fiber, a titanium alloy, and an aluminum alloy, and preferably the carbon fiber. In some embodiments of the present disclosure, a shape of the end cap is selected from the group consisting of a sheet and a hemispherical shell, and preferably the sheet. In some embodiments of the present disclosure, the shape of the end cap is consistent with a cross-section shape of the carbon fiber tube. In some embodiments of the present disclosure, the end cap has a thickness of 2.4 mm to 4 mm, and preferably 2.8 mm to 3.4 mm.

In some embodiments of the present disclosure, the carbon fiber tube is prepared by a process comprising the steps of:
subjecting a thin-layer carbon fiber prepreg and a thick-layer carbon fiber prepreg to orthogonal lamination in a carbon fiber direction to obtain a laminated carbon fiber prepreg, and rolling the laminated carbon fiber prepreg to obtain a tube blank; where a thickness ratio of the thin-layer carbon fiber prepreg to the thick-layer carbon fiber prepreg is in a range of 1:2; and
winding a biaxially oriented polypropylene (BOPP) film on a surface of the tube blank, and then conducting curing and demolding in sequence to obtain the carbon fiber tube.

In the present disclosure, a thin-layer carbon fiber prepreg and a thick-layer carbon fiber prepreg are subjected to orthogonal lamination in a carbon fiber direction to obtain a laminated carbon fiber prepreg, and the laminated carbon fiber prepreg is rolled to obtain a tube blank. In some embodiments of the present disclosure, the carbon fiber prepreg used to prepare the carbon fiber tube is purchased from Shandong Kehang New Materials Co., Ltd., China. In some embodiments of the present disclosure, a resin content in the carbon fiber prepreg is 33% to 37%, and preferably 35%. In some embodiments of the present disclosure, a model of the carbon fiber prepreg is T700-12K, and a matrix resin model of the carbon fiber prepreg is KH1301. In some embodiments of the present disclosure, a thickness ratio of the thin-layer carbon fiber prepreg to the thick-layer carbon fiber prepreg is in a range of 1:2. In some embodiments of the present disclosure, the thick-layer carbon fiber prepreg has a thickness of 0.1 mm.

In some embodiments of the present disclosure, the laminated carbon fiber prepreg is rolled onto a steel mold. There is no particular limitation on a rolling method, and any conventional rolling method in the art may be adopted.

In the present disclosure, the thin-layer carbon fiber prepreg and the thick-layer carbon fiber prepreg are subjected to the orthogonal lamination in the carbon fiber direction to obtain a laminated carbon fiber prepreg, and the laminated carbon fiber prepreg is rolled, which could ensure the hydrostatic strength of a single carbon fiber tube. In addition, this lamination method could achieve better molding quality during the rolling, and fiber wrinkles are not easy to occur.

In the present disclosure, after the tube blank is obtained, a BOPP film is wound on a surface of the tube blank, and then curing and demolding are conducted in sequence to obtain the carbon fiber tube. In some embodiments of the present disclosure, the winding is conducted at a pitch of 2 mm and a pulling force of 10 N. In some embodiments of the present disclosure, the BOPP film is a heat shrinkable film, which could provide pressure for the tube blank during curing, thereby reducing the porosity of the carbon fiber tube and ensuring the strength of the carbon fiber tube.

In some embodiments of the present disclosure, the curing includes low-temperature curing and high-temperature curing in sequence, the low-temperature curing is conducted at a temperature of preferably 75° C. to 85° C., and preferably 80° C. In some embodiments of the present disclosure, the low-temperature curing is conducted for 25 min to 35 min, and preferably 30 min. In some embodiments of the present disclosure, the high-temperature curing is conducted at a temperature of 120° C. to 140° C., and preferably 130° C. In some embodiments of the present disclosure, the high-temperature curing is conducted for 110 min to 130 min, and preferably 120 min.

In the present disclosure, there is no special requirement on a demolding method, and any conventional demolding method in the art may be adopted.

In the present disclosure, the carbon fiber tube includes a circumferential fiber mass and an axial fiber mass that are stacked in sequence, and a thickness of the circumferential fiber mass is twice that of the axial fiber mass. The carbon fibers in the thin-layer carbon fiber prepreg in the carbon fiber tube are arranged in an axial direction, while the carbon fibers in the thick-layer carbon fiber prepreg in the carbon fiber tube are arranged in a circumferential direction; an orthogonal fiber direction in the carbon fiber tube improves the compressive resistance of the carbon fiber tube.

In some embodiments of the present disclosure, the hollow glass microsphere composite foam is composed of a glass microsphere and an epoxy resin. In some embodiments of the present disclosure, the hollow glass microsphere composite foam has a density of 0.4-0.5 g/cm³, and preferably 0.43-0.46 g/cm³. In some embodiments of the present disclosure, the hollow glass microsphere composite foam has a tensile strength of 15 MPa to 20 MPa, a shear strength of 12 MPa to 18 MPa, and a compressive strength of 24 MPa to 35 MPa. In some embodiments of the present disclosure, the hollow glass microsphere composite foam is purchased from Qingdao Haoyi Industrial Co., Ltd., China.

The present disclosure further provides a method for preparing the three-phase composite described in the above technical solutions, including a method 1 and a method 2.

In the present disclosure, the method 1 includes the following steps:
preparing a mold according to a shape of the three-phase composite; and
arranging the plurality of carbon fiber tubes in the mold and pouring a mixture of a glass microsphere and an epoxy resin into the mold, and then conducting curing and molding to obtain the three-phase composite.

In some embodiments of the present disclosure, when pouring the mixture, a length of the poured mixture exceeds that of the carbon fiber tube. In some embodiments of the present disclosure, a length exceeding the carbon fiber tube is less than or equal to 5 mm, and preferably 1 mm to 3 mm.

In the present disclosure, the method 2 includes the following steps:
processing a cured hollow glass microsphere composite foam to obtain the hollow glass microsphere composite foam with pores; and
embedding the plurality of carbon fiber tubes in the pores, and then conducting sealing and adhesion to obtain the three-phase composite.

In some embodiments of the present disclosure, an adhesive for the sealing and adhesion includes an epoxy resin.

In some embodiments of the present disclosure, the processing is milling.

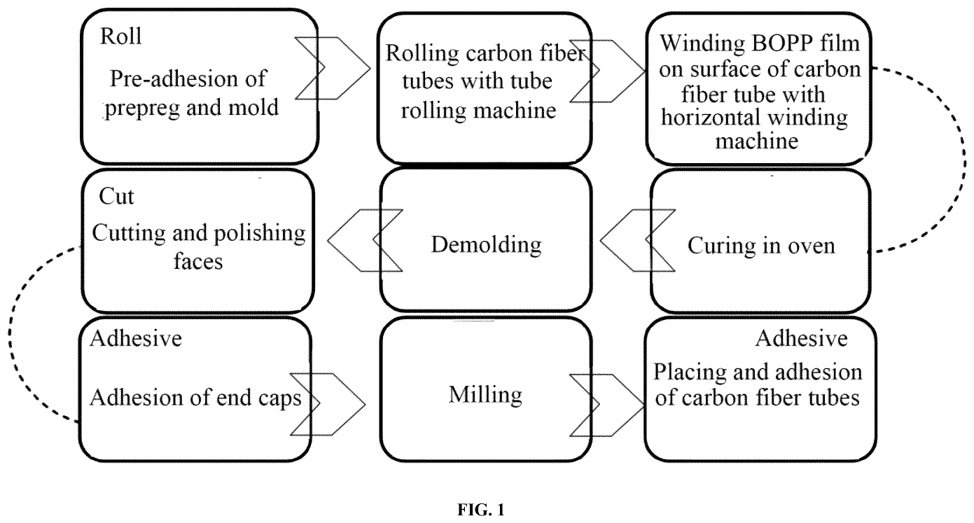

A schematic diagram of a process for preparing the carbon fiber tubes and the three-phase composite by the method 2 as an example is shown in FIG. 1. Specifically, the thin-layer carbon fiber prepreg and the thick-layer carbon fiber prepreg are subjected to orthogonal lamination in a carbon fiber direction to obtain a laminated carbon fiber prepreg, and the laminated carbon fiber prepreg is rolled to obtain a tube blank; the BOPP film is wound around a surface of the tube blank by a horizontal winding machine, and then curing and demolding are conducted in sequence; a demolded product is cut and a carbon fiber sheet material is used as an end cap to seal two ends of the carbon fiber tube; a cured hollow glass microsphere composite foam is cut and then installed and adhered the carbon fiber tube to obtain the three-phase composite.

The present disclosure further provides use of the three-phase composite described in the above technical solutions or a three-phase composite prepared by the method described in the above technical solutions as a solid buoyancy material.

In order to further illustrate the present disclosure, the technical solutions provided by the present disclosure are described in detail below in conjunction with examples, but these examples should not be understood as limiting the claimed scope of the present disclosure.

### Example 1

A thin-layer carbon fiber prepreg (with a thickness of 0.05 mm and a resin content of 35%) and a thick-layer carbon fiber prepreg (with a thickness of 0.1 mm and a resin content of 35%) purchased from Shandong Kehang New Materials Co., Ltd., China were subjected to orthogonal lamination in a carbon fiber direction to obtain a laminated carbon fiber prepreg. The laminated carbon fiber prepreg was rolled to obtain a tube blank. Where a model of the carbon fiber prepreg is T700-12K, and a model of a matrix resin of the carbon fiber prepreg is KH1301.

A BOPP film was wound on a surface of the tube blank (with a winding pitch of 2 mm, and a winding tension of 10 N) to obtain a wound tube blank. The wound tube blank was subjected to low-temperature curing at 80° C. for 30 min, and then high-temperature curing at 130° C. for 120 min, demolded, and cut. Two ends of resulting cut materials each were sealed using a carbon fiber sheet with a thickness of 3.2 mm as an end cap, so as to obtain a carbon fiber tube with an inner diameter of 27 mm, a wall thickness of 0.75 mm, and a length of 150 mm.

The carbon fiber tubes were arranged in a mold in a two-dimensional closest packing manner. Where two adjacent carbon fiber tubes had a center-to-center spacing of 31.5 mm. A mixture of a glass microsphere and an epoxy resin (purchased from Qingdao Haoyi Industrial Co., Ltd., China) with a density of 0.45 g/cm³, a tensile strength of 17 MPa, a shear strength of 15 MPa, and a compressive strength of 27 MPa was poured into pores of the arrayed carbon fiber tubes, and the three-phase composite was obtained by curing and molding.

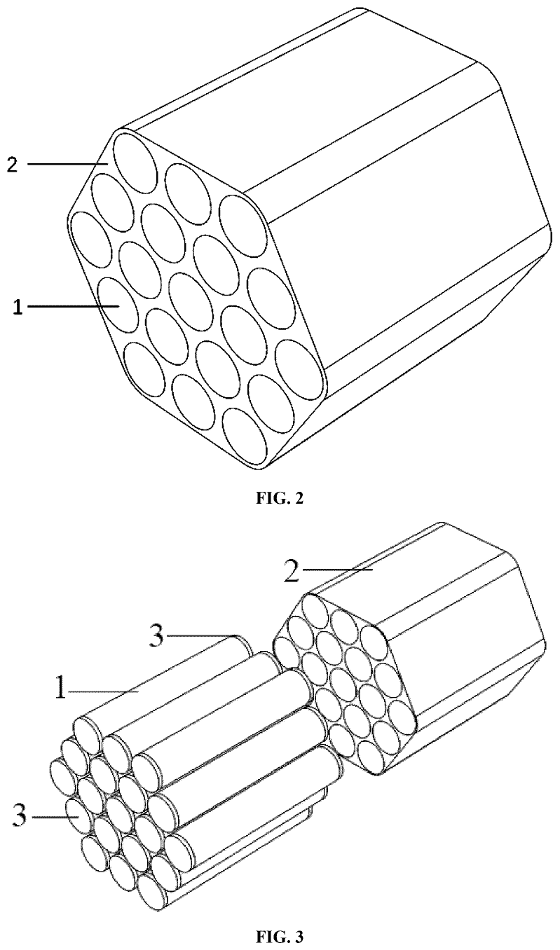

FIG. 2 shows a schematic structural diagram of the three-phase composite prepared in Example 1, where 1 refers to the carbon fiber tube, and 2 refers to a hollow glass microsphere composite foam. FIG. 3 shows an exploded diagram of the structural schematic diagram of the three-phase composite prepared in Example 1, where 1 refers to the carbon fiber tube, 2 refers to the hollow glass microsphere composite foam, and 3 refers to the end cap.

The dimensions of the three-phase composite prepared in Example 1 were measured according to the method of GB/T 6342 (Cellular plastics and rubbers—Determination of linear dimensions), and the material was weighed to calculate the equivalent density, and the results are listed in Table 1. The hydrostatic strength of the three-phase composite prepared in Example 1 was measured, and the results are listed in Table 1. The three-phase composite prepared in Example 1 was immersed in water for 24 h and measured water absorption of the three-phase composite, and the results are listed in Table 1.

TABLE 1
Performance parameters of the carbon fiber
three-phase composite prepared in Example 1

| | Equivalent | Hydrostatic | Water |
|---|---|---|---|
| | density | strength | absorption |
| Example | (g/cm³) | (MPa) | (%) |
| Example 1 | 0.3011 | 20.33 | 0.3 |

The test results in Table 1 show that the three-phase composite has a lower equivalent density and desirable compressive performance.

Although the present disclosure is described in detail in conjunction with the foregoing examples, they are only a part of, not all of, the embodiments of the present disclosure. Other embodiments can be obtained based on these embodiments without creative efforts, and all of these embodiments shall fall within the scope of the present disclosure.

What is claimed is:

1. A three-phase composite, comprising a hollow glass microsphere composite foam and a plurality of carbon fiber tubes filled in the hollow glass microsphere composite foam;
wherein the carbon fiber tubes are arranged in a two-dimensional closest packing manner, two adjacent carbon fiber tubes have a center-to-center spacing of 29.9 mm to 34 mm, and each of the carbon fiber tubes has a wall thickness of 0.45 mm to 1 mm; and two ends of each of the carbon fiber tubes each are sealed by an end cap.

2. The three-phase composite of claim 1, wherein a standard piece of the three-phase composite has a cross-section shape selected from the group consisting of a circle, a hexagon, and a square, and the standard piece of the three-phase composite has a height of 150 mm to 500 mm.

3. The three-phase composite of claim 1, wherein each of the carbon fiber tubes has an inner diameter of 26 mm to 30 mm.

4. The three-phase composite of claim 1, wherein each of the carbon fiber tubes is prepared by a process comprising the steps of:
subjecting a thin-layer carbon fiber prepreg and a thick-layer carbon fiber prepreg to orthogonal lamination in a carbon fiber direction to obtain a laminated carbon fiber prepreg, and rolling the laminated carbon fiber prepreg to obtain a tube blank; wherein a thickness ratio of the thin-layer carbon fiber prepreg to the thick-layer carbon fiber prepreg is in a range of 1:2; and
winding a biaxially oriented polypropylene (BOPP) film on a surface of the tube blank, and then conducting curing and demolding in sequence to obtain a carbon fiber tube.

5. The three-phase composite of claim 4, wherein the curing comprises low-temperature curing and high-temperature curing in sequence, the low-temperature curing is conducted at a temperature of 75° C. to 85° C. for 25 min to 35 min, and the high-temperature curing is conducted at a temperature of 120° C. to 140° C. for 110 min to 130 min.

6. The three-phase composite of claim 1, wherein the end cap is prepared by a material selected from the group consisting of a carbon fiber, a titanium alloy, and an aluminum alloy, and the end cap has a shape selected from the group consisting of a sheet and a hemispherical shell.

7. The three-phase composite of claim 1, wherein the hollow glass microsphere composite foam has a density of 0.4-0.5 g/cm³.

8. A method for preparing the three-phase composite of claim 1, comprising a method 1 or a method 2; wherein
the method 1 comprises the following steps:
preparing a mold according to a shape of the three-phase composite; and
arranging the plurality of carbon fiber tubes in the mold and pouring a mixture of a glass microsphere and an epoxy resin into the mold, and then conducting curing and molding to obtain the three-phase composite; and
the method 2 comprises the following steps:
processing a cured hollow glass microsphere composite foam to obtain the hollow glass microsphere composite foam with pores; and
embedding the plurality of carbon fiber tubes in the pores, and then conducting sealing and adhesion to obtain the three-phase composite.

9. The method of claim 8, wherein an adhesive for the sealing and adhesion comprises an epoxy resin.

10. A method of using the three-phase composite of claim 1, comprising using the three-phase composite as a buoyancy material.

11. The three-phase composite of claim 4, wherein a standard piece of the three-phase composite has a cross-section shape selected from the group consisting of a circle, a hexagon, and a square, and the standard piece of the three-phase composite has a height of 150 mm to 500 mm.

12. The three-phase composite of claim 4, wherein each of the carbon fiber tubes has an inner diameter of 26 mm to 30 mm.

13. The method of claim 8, wherein a standard piece of the three-phase composite has a cross-section shape selected from the group consisting of a circle, a hexagon, and a square, and the standard piece of the three-phase composite has a height of 150 mm to 500 mm.

14. The method of claim 8, wherein each of the carbon fiber tubes has an inner diameter of 26 mm to 30 mm.

15. The method of claim 8, wherein each of the carbon fiber tubes is prepared by a process comprising the steps of:
subjecting a thin-layer carbon fiber prepreg and a thick-layer carbon fiber prepreg to orthogonal lamination in a carbon fiber direction to obtain a laminated carbon fiber prepreg, and rolling the laminated carbon fiber prepreg to obtain a tube blank; wherein a thickness ratio of the thin-layer carbon fiber prepreg to the thick-layer carbon fiber prepreg is in a range of 1:2; and
winding a biaxially oriented polypropylene (BOPP) film on a surface of the tube blank, and then conducting curing and demolding in sequence to obtain a carbon fiber tube.

16. The method of claim 8, wherein the curing comprises low-temperature curing and high-temperature curing in sequence, the low-temperature curing is conducted at a temperature of 75° C. to 85° C. for 25 min to 35 min, and the high-temperature curing is conducted at a temperature of 120° C. to 140° C. for 110 min to 130 min.

17. The method of claim 8, wherein the end cap is prepared by a material selected from the group consisting of a carbon fiber, a titanium alloy, and an aluminum alloy, and the end cap has a shape selected from the group consisting of a sheet and a hemispherical shell.

18. The method of claim 8, wherein the hollow glass microsphere composite foam has a density of 0.4-0.5 g/cm³.

19. The method of claim 10, wherein a standard piece of the three-phase composite has a cross-section shape selected from the group consisting of a circle, a hexagon, and a square, and the standard piece of the three-phase composite has a height of 150 mm to 500 mm.

20. The method of claim 10, wherein each of the carbon fiber tubes has an inner diameter of 26 mm to 30 mm.
